(19) United States
(12) Patent Application Publication
(10) Pub. No.: US 2008/0115603 A1
(43) Pub. Date: May 22, 2008

(54) Fuel-free motive power installation

(76) Inventor: Yun-Ting Yeh, Chungli City (TW)

Correspondence Address: TROXELL LAW OFFICE PLLC;SUITE 1404, 5205 LEESBURG PIKE, FALLS CHURCH, VA, 22041, US

(21) Appl. No.: 11/603,113

(22) Filed: Nov. 22, 2006

(51) Int. Cl. F03G 7/00

(52) U.S. Cl. 74/25

(57) ABSTRACT

A fuel-free motive power installation comprising two slides respectively disposed on both sides of a lever; two elastic return structures respectively disposed either on top of or below the lever; and two traction rods each with both sides respectively pivoted to a slide and a dancer from a hammer; the swinging dancer respectively applying thrust and pull to both traction rods for the slide to laterally travel; the lever pressing against each elastic return structure to take advantage of the return force from the elastic return structure and central gravity of the hammer for the lever to swing up and down in opposite direction to produce motive power; and a linking structure transmitting the motive power to an energy collection structure thus to produce energy.

### BACKGROUND OF THE INVENTION

(a) Field of the Invention

The present invention is related to a fuel free motive power installation, and more particularly, to one generates motive power without by taking advantage of lateral movement of two slides and to swing up and down as the return force from an elastic return structure pushes the lever.

(b) Description of the Prior Art

For a long time, electric power for our consumption is supplied from up-scaling power plants. Power plant generates power by consumption of fossils or nuclear energy or other forms of natural resources. Affected by environmental awareness and oil crisis, people start to seek alternatives from other natural resources for power generation, e.g., horizontal axis wind velocity, solar energy, geodetic heat, tidal, and hydraulic powers. However, any alternative is confined due to environmental conditions or costing problem to prevent it form being made in smaller scale for common application.

Any means of power generation relying upon natural forces and resources as mentioned above though have achieved its purpose is found with the following flaws:

1. Mankind will eventually consume up the natural resources, if not sooner when considering the massive exploitation. Even nuclear energy or fossil appears to be an ideal option as fuel for power generation, enormous costs involved in construction and maintenance as well as resulted pollution to the environment warrants improvement; and

2. Natural force though may be a substitute for power source to correct the negative effects from power generation using nuclear energy or fossil, it however is not predicable since people are unable to foretell when there will be a typhoon to strike or when a river may run dry up. In the absence of wind or water, the power plant immediately becomes inoperative.

### SUMMARY OF THE INVENTION

The primary purpose of the present invention is to provide a fuel-free motive power installation; wherein, lever moment is changed by taking advantage of the lateral motion of two slides while a return force applied from an elastic return structure and central gravity of a hammer to push the lever to swing up and down for producing motive power.

To achieve the purpose, the present invention is comprised of a lever, two slides, two traction rods, a hammer and two elastic return structures. A central pivot is disposed to the lever with both slides respectively arranged to both sides of the lever. Each elastic return structure is either disposed on top of or below the lever. One end of the elastic return structure is pivoted to the slide. Another end of each traction rod is pivoted to a dancer of the hammer. When a heavy load is pulled to swing the dancer, the dancer respectively applies thrust and pull to both traction rods disposed on both sides of the dancer for the slide to laterally travel to the inclined side and thus to change the moment of the lever. Meanwhile return force exerted from the elastic return structure and central gravity of the hammer causes the lever to swing up and down in opposite direction; and finally the motive power is transmitted to an energy collection structure through a linking structure to produce energy.

### BRIEF DESCRIPTION OF THE DRAWINGS

FIG. 1 is a schematic view showing construction of a first preferred embodiment of the present invention.

FIG. 2 is a schematic view showing a level swinging up and down in the first preferred embodiment of the present invention.

FIG. 3 is a schematic view showing construction of a second preferred embodiment of the present invention.

FIG. 4 is a schematic view showing a local construction of the second preferred embodiment of the present invention.

FIGS. 5(A) and 5(B) are schematic views showing a lever swinging up and down in the second preferred embodiment of the present invention.

FIG. 6 is a schematic view showing construction of a third preferred embodiment of the present invention.

FIG. 7 is another schematic view showing construction of the third preferred embodiment of the present invention.

FIG. 8 is a schematic view showing construction of a fourth preferred embodiment of the present invention.

FIGS. 9(A) and 9(B) are schematic views showing a lever swinging up and down in the fourth preferred embodiment of the present invention.

FIG. 10 is a schematic view showing construction of a fifth preferred embodiment of the present invention.

### DETAILED DESCRIPTION OF THE PREFERRED EMBODIMENTS

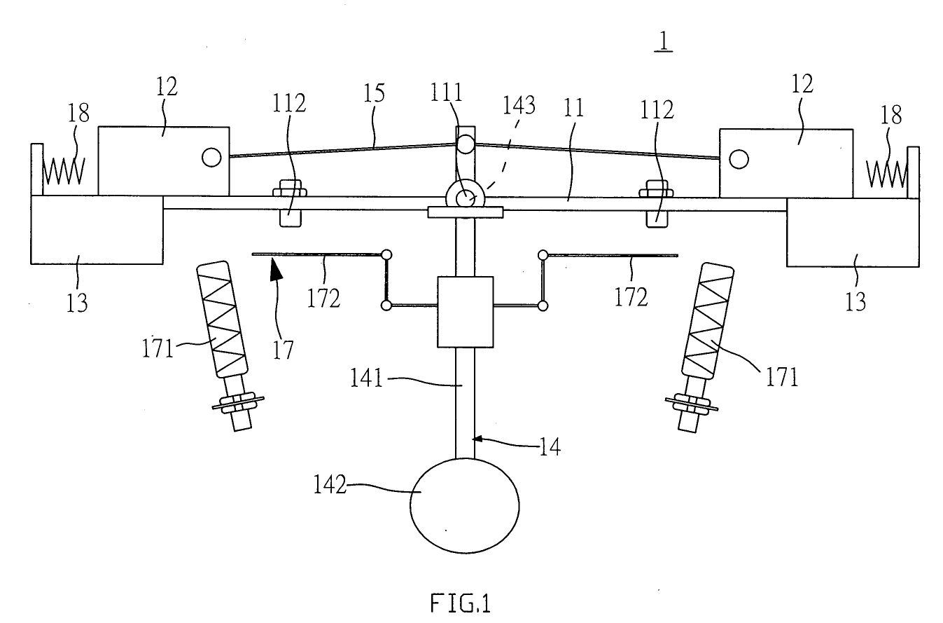

Referring to FIG. 1, a fuel-free motive power installation 1 of the present invention includes a lever 11, disposed with a central pivot 111; two slides 12 are respectively disposed on both sides of the lever 11; a heavy load 13 is provided below each of both sides of the lever 11; and a press member 112 is each disposed beneath both sides of the lever 11.

Two slides 12 respectively disposed on both sides of the lever 11 and are respectively connected to a hammer 14 by means of a traction rod 15; and an elastic member 18 is each disposed externally to each slide 12 for the slide 12 to press against to and each elastic member 18 may be fixed to the lever 11.

One end of each traction rod 15 is pivoted to the slide 12 by means of a bearing (not illustrated) while the other end of each traction rod 15 is pivoted to the hammer 14 also by means of another bearing (not illustrated).

The hammer 14 is comprised of a dancer 141 and a heavy object 142; two traction rods 15 are pivoted to both sides of the dancer 141 at where appropriately. The dancer 141 is provided with a pivot 143 and the pivot 143 holds against where the dancer 141 is pivoted to both traction rods 15. As illustrated in this preferred embodiment, the pivot 143 is located at the central pivot 111 of the lever 11.

Two elastic return structures 17 are respectively disposed on top of or below both sides of the lever 11 at the same time or with one being on top of and the other below the lever 11. As illustrated, both elastic return structures 17 are disposed below both sides of the lever in the preferred embodiment. The elastic return structure 17 may be related to a rubber, coil, spring, elastic tag, air cylinder, oil cylinder or any other elastic object. Each elastic return structure 17 is capable of adjusting the width of the spacing between the elastic return structure 17 and the lever 11. As illustrated, the elastic return structure 17 of the preferred embodiment includes a spring 171 and an elastic tag 172.

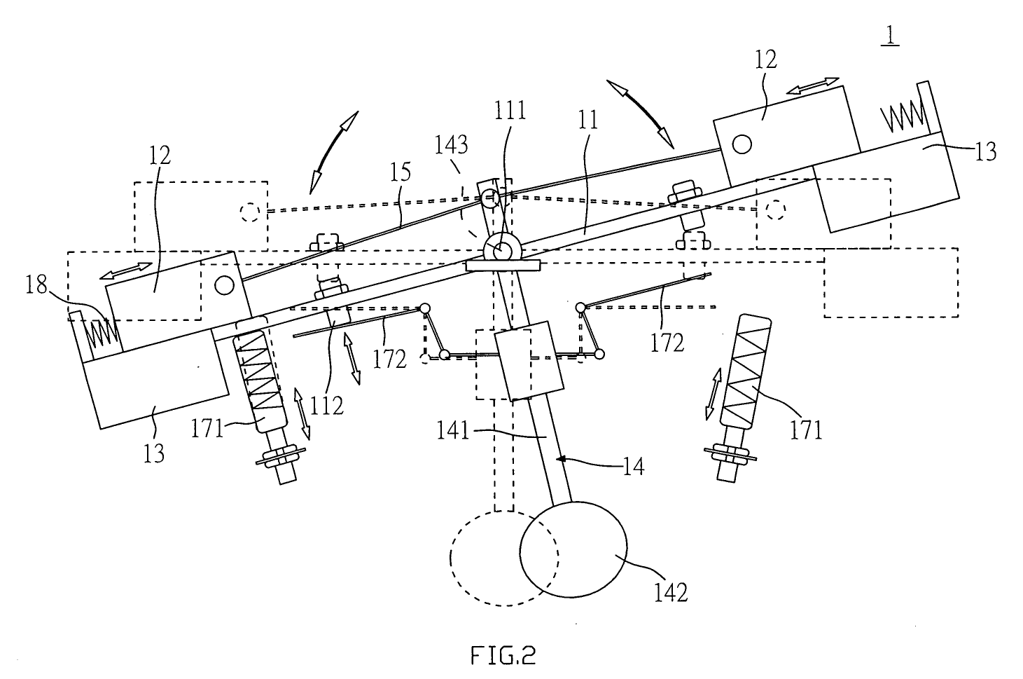

As illustrated in FIG. 2, the dancer 141 is pulled to its right to cause the heavy object 142 to lean to its right; in turn the dancer 141 respectively applies thrust and pull to both traction rods disposed to the left side and the right side of the dancer 141 thus to cause both slides 12 to travel to the left. The changed moment of the lever 11 forces the lever 11 to decline towards its left and when the lever 11 reaches the lowest point, the lever 11 presses the elastic return structure 17 (the spring 171) disposed below the lever 11; meanwhile the press member 112 holds against the elastic return structure 17 (the elastic tag 172) for the elastic return structure 17 to enter into a compressed status. The slide 12 on the left end of the lever 11 holds against the elastic member 18 disposed externally to the slide 12 for the elastic member 18 to enter into a compressed status.

At the time the left end of the lever 11 inclines to its lowest point when pushed by the slide 12 on the left of the lever 11 and the hammer 14 swings to the highest point to its right, the return force stored in the elastic member 18 held against by the slide 12 causes the slide to travel in the opposite direction and that stored in the elastic return structure 17 below and held against by the lever 11 also causes the lever 11 to swing in the opposite direction, i.e., to its right. The central gravity of the hammer 14 causes both of the dancer 141 and the lever 11 to incline in opposite direction at the same time thus to force the lever 11 to incline to its right. Once the lever 11 inclines to reach its lowest point to its right, the slide 12 on its right end presses against the elastic member 18 disposed externally to the slide 12 and the lever 11 presses against the elastic return structure 17 disposed below the lever 11. Finally, return forces respectively from the elastic member 18 and the elastic return structure 17 and the central gravity from the hammer 14 jointly cause the lever 11 to swing in the opposite direction.

Accordingly, when the hammer 14 swings to either side, the slide 12 travels in the opposite direction to change the moment of the lever 11 for the lever 11 to swing to the other side. Meanwhile, the slide 12 presses against the elastic member 18 disposed externally to the slide 12 and the lever 11 presses against the elastic return structure 17. Once the hammer 14 swings to its highest point and the lever 11 inclines to its lowest point, return forces respectively stored in the elastic member 18 and the elastic return structure 17, and the central gravity from the hammer 14 jointly cause the lever 11 to swing in opposite direction thus for the lever 11 to continue swinging up and down.

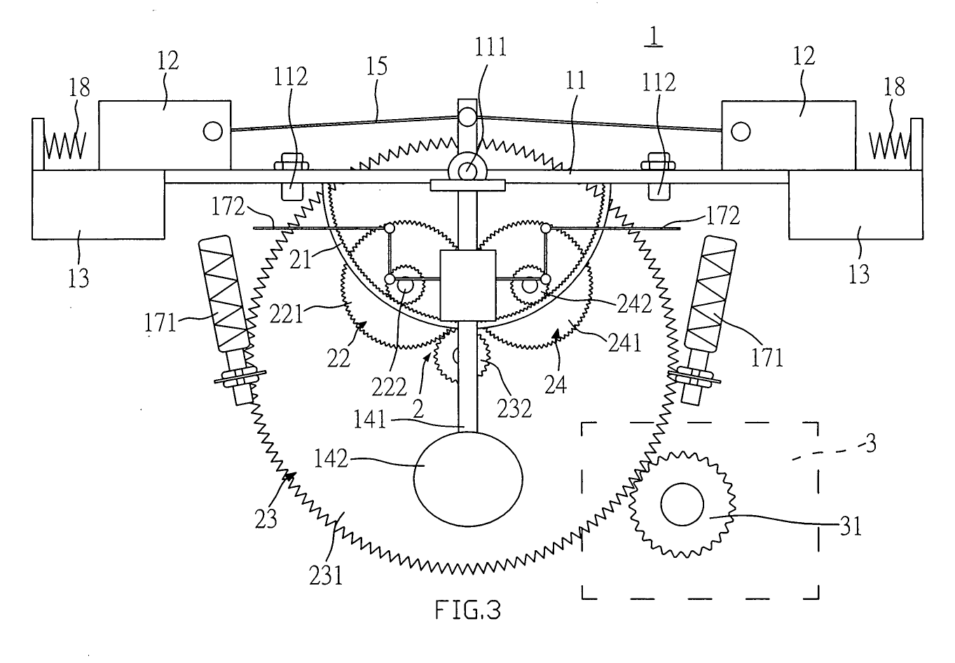

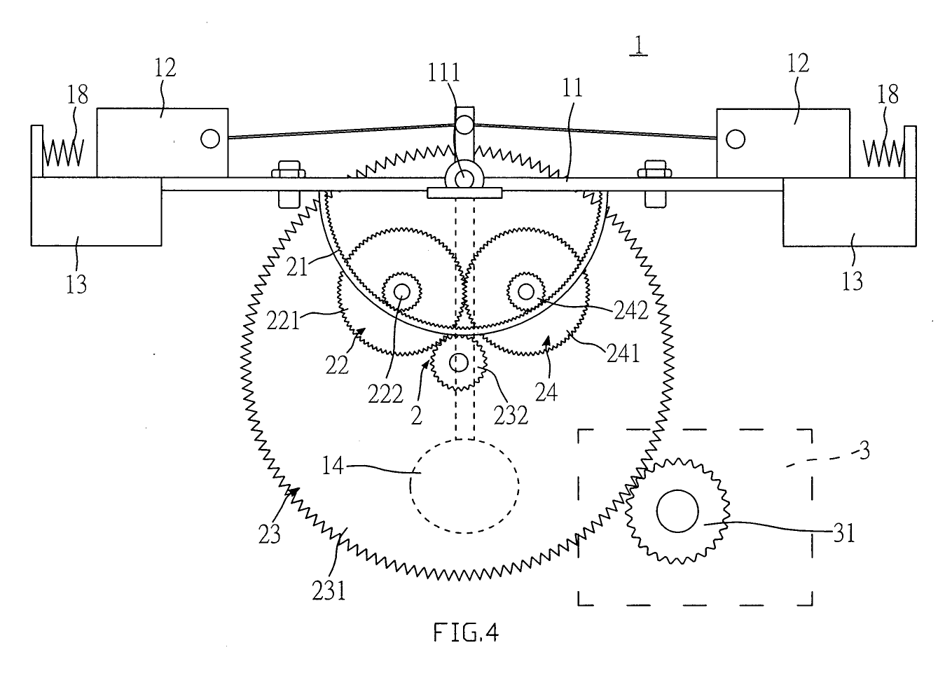

Furthermore, a linking structure 2 is disposed to one side of the motive power installation to transmit the motive power produced from the lever 11 swinging up and down to an energy collection device 3 as illustrated in FIGS. 3 and 4. Wherein, the linking structure 2 includes one or a plurality of rack 21 in semi-circular form with one side of the rack 21 disposed at where below one side of the lever 11 and another side of the rack crossing the central point 111 of the lever and is disposed below another side of the lever 11.

A first transmission gear set 22 is disposed with a first gearwheel 221 and a first pinion 222 coaxially revolving with the first transmission gear set 22; the first pinion 222 related to a one-way gear is intermeshed with the rack 21.

A second transmission gear set 23 is disposed with a second gearwheel 231 and a second pinion 232 coaxially revolving with the second transmission gear set 23; and the second pinion 232 is intermeshed with the first gearwheel 221 of the first transmission gear set 22.

A third transmission gear set 24 is disposed with a third gearwheel 241 and a third pinion 242 coaxially revolving with the third transmission gear set 24; the third gearwheel 241 is intermeshed with the first gearwheel 221 of the first transmission gear set 22; and the third pinion 242 is related to a one-way gear.

The energy collection structure 3 may be related to a power generation unit includes a transmission 31 intermeshed with the second gearwheel 231 of the second transmission gear set 23; and the transmission may be related to a transmission shaft.

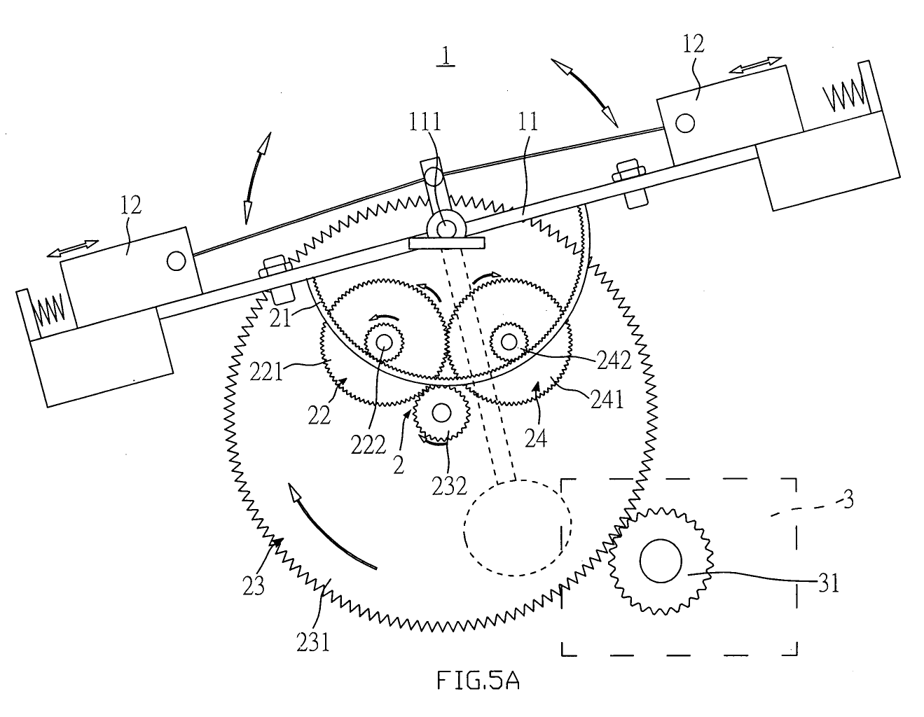

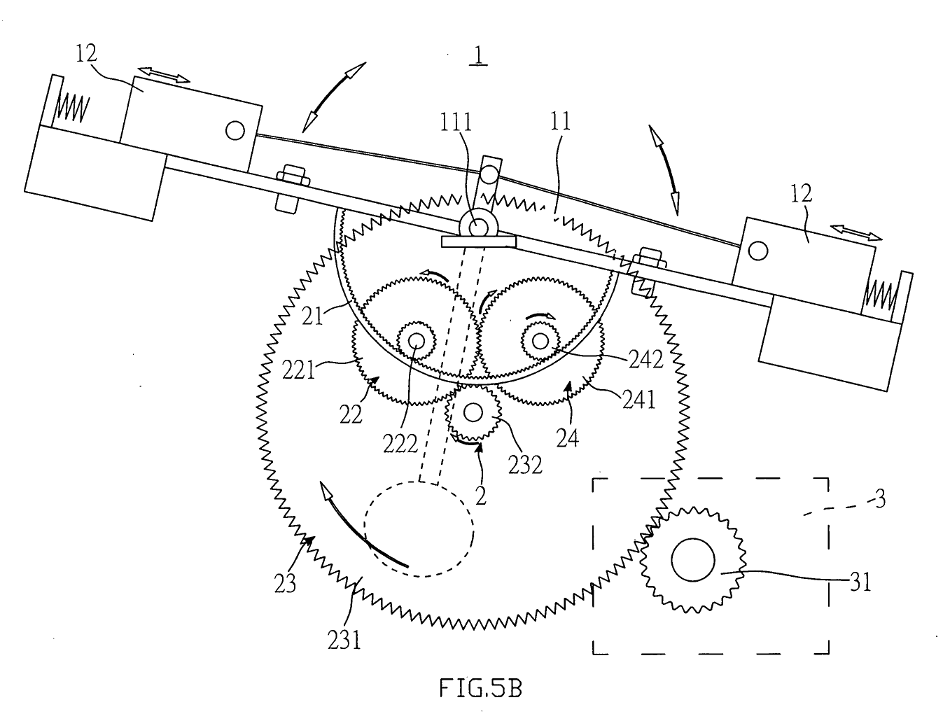

In practice as the lever 11 swings up and down as illustrated in FIG. 5(A), the left end of the lever 11 swings downward to cause the rack 21 below the lever 11 to swing. The swinging rack 21 first drivers the first pinion 222 to revolve while the third pinion 242 is idling since it is related to a one-way gear. Meanwhile, the first gearwheel 221 coaxially disposed with the first pinion 222 coaxially revolves. The first gearwheel 221 respectively drives the second pinion 232 and the third gearwheel 241 to revolve, and the second gearwheel 231 coaxially disposed with the second pinion 232 to coaxially revolve to further cause the second gearwheel 231 to drive the transmission 31 to revolve.

Conversely as illustrated in FIG. 5(B), the right side of the lever 11 swings downward for the rack 21 disposed below the lever 11 to swing to first drive the third pinion 242 to revolve while the first pinion 222 is idling since it is related to a one-way gear. Meanwhile, the third gearwheel 241 disposed coaxially with the third pinion 242 coaxially revolves, and the third gearwheel 241 driver the first gearwheel 221 to revolve. The revolving first gearwheel 221 drives the second pinion 232 to revolve and in turn the second gearwheel 231 disposed coaxially with the second pinion 232 axially revolves thus to cause the second gearwheel 231 to drive the transmission shaft 31 to revolve, and further to drive the energy collection device 3 to operate.

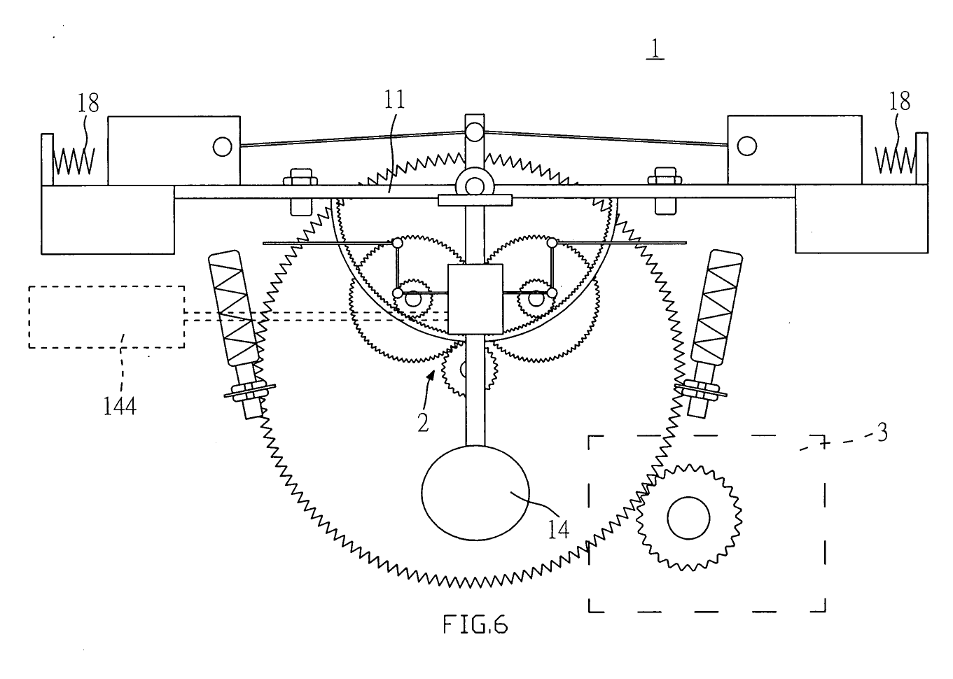

In addition, a driving member 144 is disposed at where appropriately to the dancer 141 as illustrated in FIG. 6 to cause the hammer 14 to swing thus to further cause the lever 11 to repeat swinging up and down while transmitting through the linking structure 2 to the energy collection device 3.

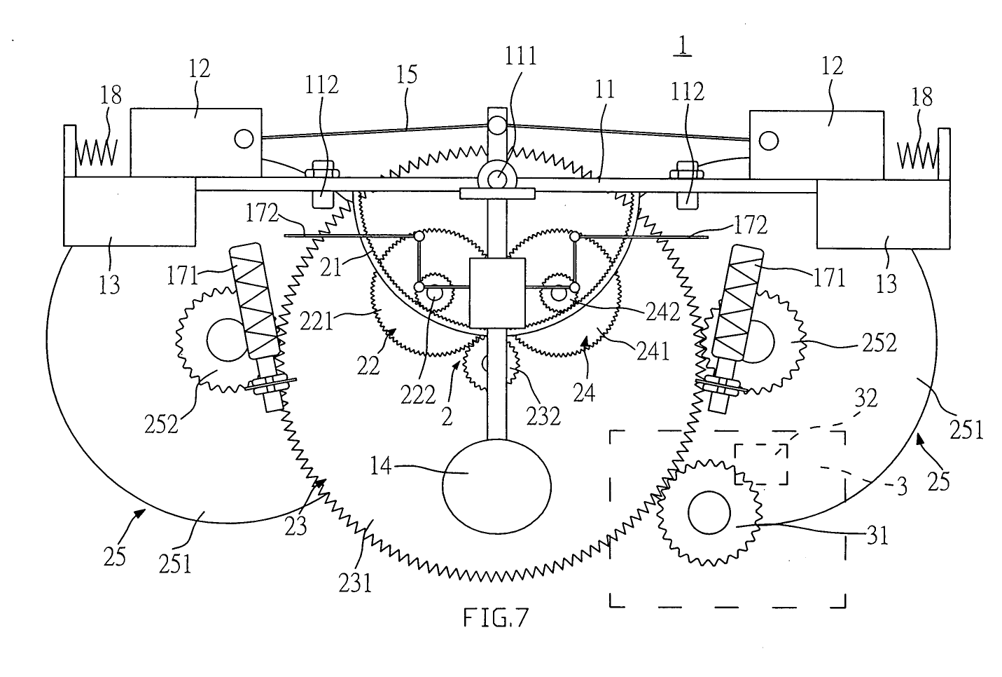

A fourth transmission gear set 25 is further disposed to the linking structure 2 as illustrated in FIG. 7. The fourth transmission gear set 25 is disposed with a fourth flywheel 251 and a fourth pinion 252. The fourth pinion 252 is intermeshed with the second gearwheel 231 thus for it to drive the fourth pinion 252 to revolve and further to drive the fourth flywheel 251 to coaxially revolve. The energy collection structure 3 is further disposed with a clutch 32 to control whether the transmission shaft 31 to idle or not. In practice, the lever 11 swings up and down, the rack 21 drives the first pinion 222 or the third pinion 242 to revolve thus to cause the second pinion 232 to continue revolving. Meanwhile the second gearwheel 231 coaxially revolves to cause the second gearwheel 231 to drive the transmission shaft 31 and the fourth pinion 252 to revolve. However, to this moment the energy stored is at lower level since the lever 11 is just about to swinging up and down; therefore, the clutch 32 of the energy collection device 3 controls the transmission shaft 31 to idle. Once the energy stored reaches its higher lever (as told from the rpm of the fourth flywheel 251 driven by the fourth pinion 252), the clutch 32 enables the transmission shaft to revolve for transmitting the motive power to drive the energy collection structure 3 to operate for producing motive power.

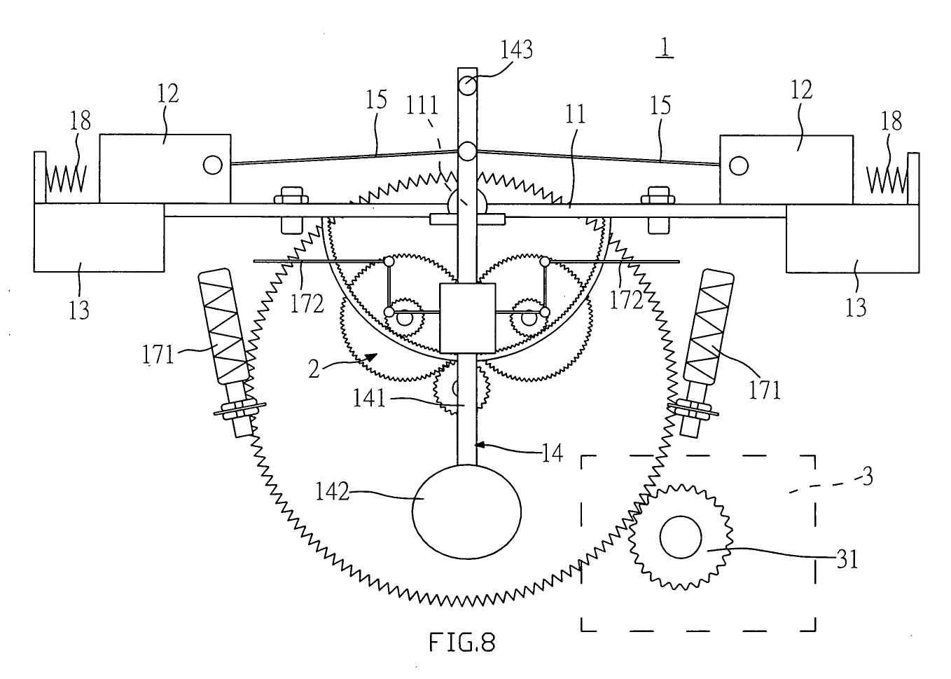

Alternatively, as illustrated in FIG. 8, the motive power installation includes the lever 11, two slides 12, two traction rods 15, a hammer 14 and two elastic return structures 15. The lever 11 is disposed with the central pivot 111 while two slides 12 are respectively disposed to both sides of the lever 11 and two elastic return structures 17 are respectively disposed below the lever 11. Each slide 12 is disposed to its external side the elastic member 18. One end of each traction rod 15 is pivoted to the slide 12 and the other end of each traction rod 15 is pivoted to the dancer 141 of the hammer 14. The dancer 141 is disposed with a pivot 143 and in this preferred embodiment the pivot 143 is disposed at where higher the point the dancer 141 is pivoted to both traction rods 15.

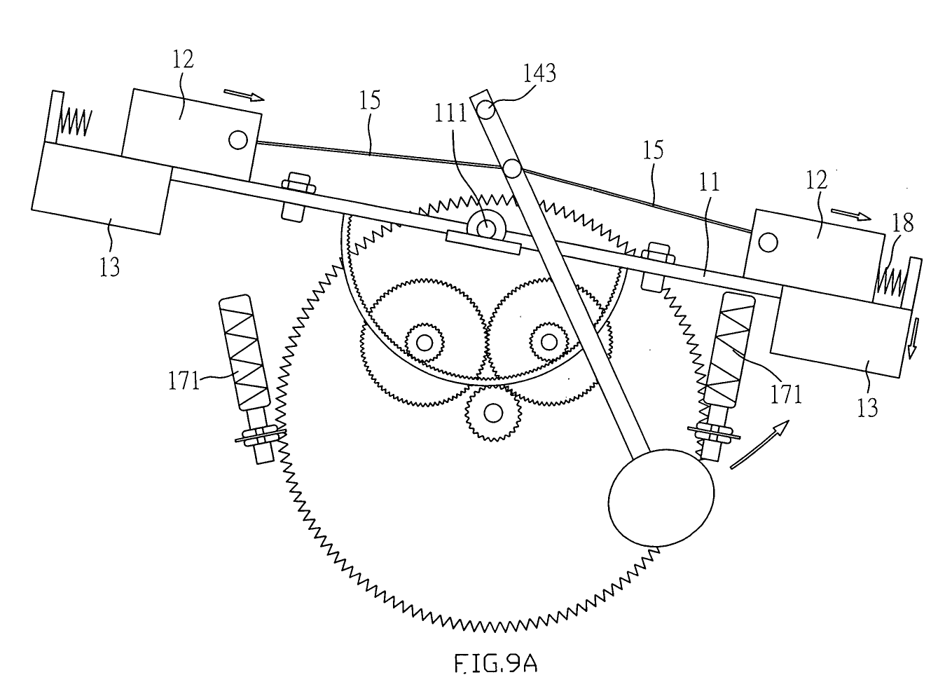

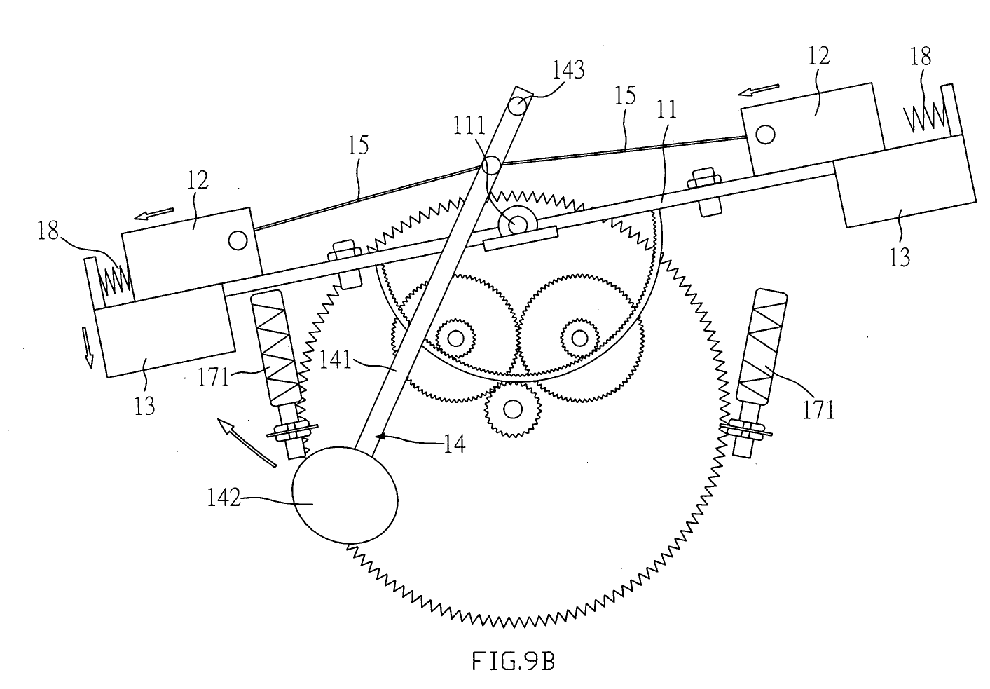

In practice as illustrated in FIGS. 9(A) and 9(B), the dancer 141 is pulled to its right for the heavy object 142 to incline to its right while the dancer 141 respectively applies pull and thrust to the left and the right traction rods 15. According, two slides 12 on both sides to move to the right with the slide 12 on the right end to press against the elastic member 18 thus to change the moment of the lever 11 and the heavy object 142 also inclines to its right to apply its central gravity. The sum of the weight of both slides 12 and the central gravity from the heavy object 142 forces the lever 11 to incline to its right and swing lower. Once the right side of the lever 11 inclines and reaches to its lowest point, the slide 12 on the right holds against the elastic member 18 disposed to the outer side of the slide 12 and the lever 11 presses against the elastic return structure 17 (the spring 171) disposed below the lever 11 to put both of the elastic member 18 and the elastic return structure 17 to be gradually compressed.

When the right slide 12 forces the right side of the lever 11 to incline down to its lowest point and the hammer swings to its left at the highest point, the return force stored in the elastic member 18 held against by the slide 12 causes the slide 12 to travel in opposite direction and the force stored in the elastic return structure 17 disposed below the level 11 causes the lever 11 to swing in the opposite direction (i.e., to its left). Meanwhile, the central gravity from the hammer causes the dancer 141 to incline in the opposite direction thus to force the lever 11 to incline to its left and swing lower. Conversely, when the left side of the level 11 inclines to its lowest point, the slide 12 to its left presses against the elastic member 18 disposed externally to the slide 12 and the lever 11 presses against the elastic return structure 17 disposed below the lever. The lever 11 swings in the opposite direction caused by the central gravity of the hammer 14 and return forces applied by the elastic member 18 and the elastic return structure 17.

When the hammer 14 swings to either side, the sliders 12 laterally travel in the same side to change the moment of the level 11 thus to cause it to swing in the same direction. The slide 12 on the declined side of the lever 11 presses against the elastic member 18 disposed externally to the slide 12 and the lever 11 presses against the elastic return structure 17. Once the hammer 14 swings to its highest point and the lever 11 swings to its lowest point, the sum of return forces respectively stored in the elastic member 18 and the elastic return structure 17 as well as the central gravity of the hammer 14 causes the lever 11 to swing in opposite direction to keep it swinging up and down. The linking structure 2 transmit the motive power created from the cycling of swinging up and down by the lever 11 to the energy collection structure as illustrated in FIG. 8 to produce energy.

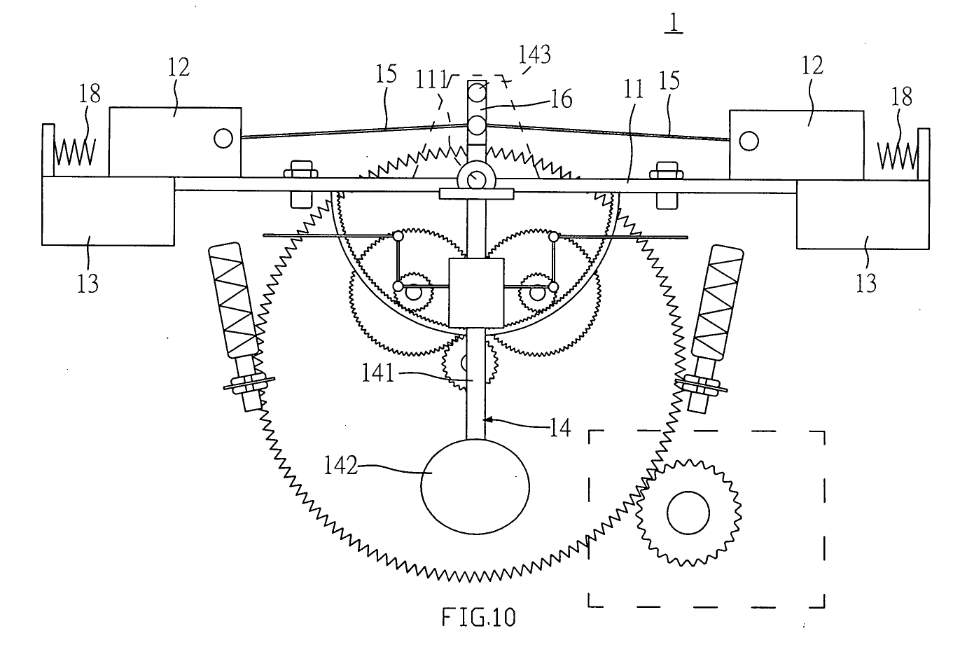

As illustrated in FIG. 10, the motive power installation 1 includes the lever 11, two slides 12, two traction rods, 15, the hammer 14, and two elastic return structures 17. Wherein, the lever 11 is disposed with a central pivot 111 and two slides 12 are respectively disposed on both sides of the lever 11 and two elastic return structures 17 are respectively disposed below the lever 11. The elastic member 18 is disposed externally to each slide 12 for the slide 12 to press against the elastic member. One end of each traction rod 15 is pivoted to the slide 12 and the other end of each traction rod 15 is pivoted to a post 16. The dancer 141 and the heavy object 142 are connected to the hammer 14. The dancer 141 is disposed with a pivot 143 and one side of the post 16 is pivoted to the pivot 143. As illustrated, in this preferred embodiment, the pivot 143 is disposed at a level higher than where both traction rods 15 are pivoted to the post 16 so that when the dancer 141 swings, both traction rods 15 on both sides are respectively pushed and pulled by the post for both slides 12 to travel on the lever 11.

It is to be noted that the present invention provides the following advantages:

1. The present invention helps a nation reduce, if not avoid, its excessive reliance upon natural resources by providing a fuel free motive power installation to break the myth that any mechanical power must be produced by consuming fuel. In the present invention, the inherited motive power of mechanism substitutes the fuel consumption to minimize damage to natural resources by human factors.

2. Reduced exhaustion from burning petrol oil and coals is beneficial to our efforts in protecting the natural environment. Massive consumption of energy sources including coal and petrol oil in the industrial activities and transportation at the same time also creates all sorts of dusts and exhaustions present extremely serious pollution to the air and even the damage to the ozone layer that is crucial to the survival of mankind.

3. The present invention alleviates the reliance upon conventional energy sources including petrol oil and coals by the industry, national defense, transportation and communications, and electric power.

4. The present invention allows the maximal relief to the tension created in the strategic deposit of patrol oil for a nation.

5. The present invention will induce historical reformation to the motive power equipment for the military forces of a nation.

6. The present invention helps a nation stop making enormous inputs that appear to be never enough in solving the power supply problems by removing the ever tension situation in providing sufficient power.

7. With the present invention, we may wave goodbye to gasoline, diesel, and natural gas.

The prevent invention provides an improved structure of a fuel-free motive power installation, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A fuel-free motive power installation including a lever provided with a pivot; two slides respectively disposed on both sides of the lever; a hammer connected to a dancer and a heavy load; two traction rods with one end of each traction rod pivoted to a slide and another end to the dancer; and two elastic return structures respectively disposed either on top of or below both sides of the lever.

2. The fuel-free motive power installation as claimed in claim 1, wherein the dancer is disposed with a pivot at an level either higher or lower than that of the location where the dancer is pivoted to both traction rods.

3. The fuel-free motive power installation as claimed in claim 1, wherein a linking structure is further disposed to the motive power installation to transmit motive power created from the lever swinging up and down to an energy collections structure.

4. The fuel-free motive power installation as claimed in claim 1, wherein each of both sides of the lever is disposed with a heavy load.

5. The fuel-free motive power installation as claimed in claim 1, wherein the elastic return structure is related to rubber, coil, spring, resilient tag, air cylinder or oil cylinder.

6. The fuel-free motive power installation as claimed in claim 3, wherein the linking structure includes a rack having its one side disposed at where below one side of the lever; another side of the rack crossing over the pivot and disposed at where below another side of the lever; a first transmission gear set disposed with a first gearwheel and a first pinion revolving coaxially with the first transmission gear set coaxially revolving, and the first pinion and the rack being intermeshed to each other; a second transmission gear set disposed with a second gearwheel and a second pinion revolving coaxially with the second transmission gear set, and the second pinion and the first gearwheel from the first transmission gear set being intermeshed to each other; and a third transmission gear set disposed with a third gearwheel and a third pinion revolving coaxially with the third transmission gear set, and the third pinion and the rack being intermeshed to each other, and the third gearwheel and the first gearwheel being intermeshed to each other.

7. The fuel-free motive power installation as claimed in claim 6, wherein the rack is related to a semi-circular structure of rack.

8. The fuel-free motive power installation as claimed in claim 6, wherein the first and the third pinions are each related to a one-way gear.

9. The fuel-free motive power installation as claimed in claim 3, wherein the energy collection structure includes a transmission, and the transmission is intermeshed with the second gearwheel of the second transmission gear set.

10. The fuel-free motive power installation as claimed in claim 3, wherein the linking structure is further disposed with one or a plurality of fourth transmission gear set; and the fourth transmission gear set is disposed with a fourth flywheel and a fourth pinion gear revolving coaxially with the fourth transmission gear set; and the fourth pinion and the second gearwheel are intermeshed to each other.

11. The fuel-free motive power installation as claimed in claim 3, wherein the energy collection structure is further disposed with a clutch.

12. The fuel-free motive power installation as claimed in claim 1, wherein an elastic member is disposed to the outer side of each of both slides.
